(19) United States
(12) Patent Application Publication
(10) Pub. No.: US 2016/0147412 A1
(43) Pub. Date: May 26, 2016

(54) INDICATING A PORTION OF CONTENT PREVIOUSLY DISPLAYED

(71) Applicant: Mori Love, Yorba Linda, CA (US)

(72) Inventor: Mori Love, Yorba Linda, CA (US)

(21) Appl. No.: 14/549,334

(22) Filed: Nov. 20, 2014

(51) Int. Cl. G06F 3/0484; G06F 17/21

(52) U.S. Cl. CPC G06F 3/04842; G06F 17/212

(57) ABSTRACT

Methods, systems, and apparatus, including computer programs encoded on a computer storage medium, for displaying content are described. A preview item is provided for display on a mobile device. The preview item is associated with a content item, and the preview item includes preview text excerpted from the content item. A user selection of the preview item is received. In response to the user selection of the preview item, the preview text is identified within the content item. The content item and an indication of the preview text's location within the content item are provided for display on the mobile device. Providing the indication can include, for example, highlighting text at the end of the preview text within the content item.

### BACKGROUND

Previews of web content are often presented on websites or in mobile device applications. The previews typically include a text snippet or an image excerpted from the full version of the web content. A user may read the preview and decide to view the full version of the web content. When a user selects to view the full version, the full version is often presented in another view on the website or mobile device application.

### SUMMARY

This specification relates to efficiently directing a user to a location within an item of content where a portion of previewed content ends.

Some implementations of the present disclosure indicate the location of a preview text within the larger body of a text from which the preview text was excerpted. In some instances, implementations of the present disclosure identify preview text on a first interface displayed to a user; in response to receiving a user selection to view a second interface, locating the preview text within a body of text contained in the second interface; and highlighting the preview text, allowing the user to quickly determine where to pick up reading in the second interface. In some implementations, the preview text is highlighted in high contrast color or visually demarcated in another manner (e.g., outlined, underlined, bolded, etc.). In some implementations, a format of the preview text is changed to distinguish the preview text from other text in the body of text. In some implementations, only a portion of the preview text is highlighted.

Particular implementations of the subject matter described in this specification can be implemented so as to realize one or more of the following advantages. Implementations may enable a user to efficiently find the end of preview text in a web article. Implementations also may adapt how the end of preview text is indicated to a user based on a display size or other factors. The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example system in accordance with implementations of the present disclosure.

FIGS. 2A-2G depict an example use case in accordance with implementations of the present disclosure.

FIG. 3 depicts an example process that can be executed in accordance with implementations of the present disclosure.

FIG. 4 depicts another example process that can be executed in accordance with implementations of the present disclosure.

Like reference numbers and designations in the various drawings indicate like elements.

### DETAILED DESCRIPTION

Implementations of the present disclosure automatically indicate, within a body of text from which the preview text was excerpted, a location associated with the end the preview text. Thus, when a user views the body of text, the user can locate the beginning of unread text without necessarily having to reread the preview text or visually scan for the end of the preview text.

Implementations of the present disclosure can identify preview text on a first display presented to a user (e.g., a first webpage or a first application interface). In response to receiving a user selection, the preview text can be identified within a body of text contained in the second display presented to a user (e.g., a second webpage or a second application interface), and the preview text can be visually indicated (e.g., highlighted, etc.) in the second display. The visual indication allows the user to quickly determine where to pick up reading in the second display. In some implementations, the preview text is highlighted in high contrast color. In some implementations, a format of the preview text is changed to distinguish the preview text from other text in the body of text. In some implementations, only a portion of the preview text (e.g., the last 1-10 words) is highlighted.

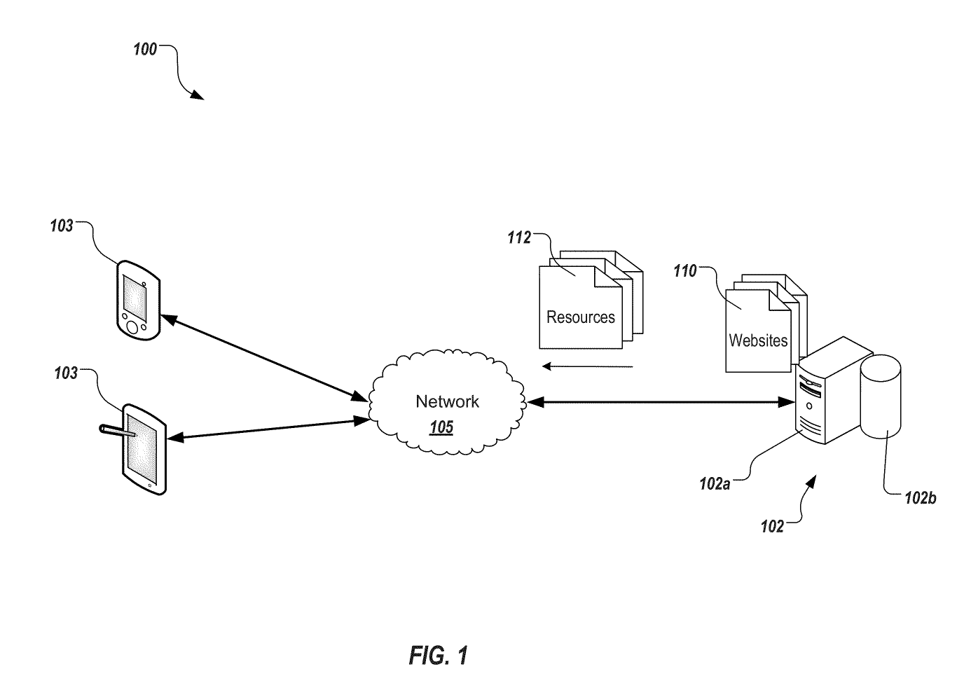

FIG. 1 depicts an example system 100 that can execute implementations of the present disclosure. The example system 100 includes content servers 102 in communication with mobile devices 103 via one or more networks 105. The content servers 102 can include a computing device 102a and computer-readable memory provided as a persistent storage device 102b, and can represent various forms of server systems including, but not limited to, a web server, an application server, a proxy server, a network server, or a server farm. For example, content servers 102 may include a server or set of servers that are co-located with one another or geographically distributed. Content servers 102 also may include cloud-based or edge network equipment and services. Content servers 102 may host one or more websites. In some examples, a website 110 is provided as one or more resources 112 associated with a domain name and hosted by one or more content servers 102. An example website is a collection of webpages formatted in an appropriate machine-readable language, e.g., hypertext markup language (HTML) that can contain text, images, multimedia content, and programming elements, e.g., scripts. Each website 110 is maintained by a publisher, e.g., an entity that manages and/or owns the website.

In some examples, a resource 112 is data provided over the network 105 that is associated with a resource address, e.g., a uniform resource locator (URL). In some examples, resources 112 that can be provided by a website 110 include webpages, web search engines, web-content aggregation, word processing documents, portable document format (PDF) documents, images, video, and feed sources, among other appropriate digital content. The resources 112 can include content, (e.g., text, images, and video) and may include embedded information, (e.g., meta information and hyperlinks), and/or embedded instructions (e.g., scripts).

The example mobile devices 103 may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the mobile devices 103 typically includes a display component (e.g., a touchscreen), a memory, a communication interface (e.g., a radio interface, a data link, etc.), a user interface (e.g. a touchscreen, buttons, etc.), and one or more processors. A mobile device 103 may have internal or external storage components for storing data and programs such as an operating system and one or more application programs. Mobile devices 103 may be capable of requesting and receiving resources 112 over the network 105. A mobile device 103 can execute a user application (e.g., a web browser, or a mobile web app e.g., FLIPBOARD provided by FLIPBOARD, INC. of Palo Alto, Calif.) to facilitate the sending and receiving of data over the network 105.

The example network 105 can include a large network or combination of networks, such as a local area network (LAN), wide area network (WAN), a public data network (e.g., the Internet), a private data network (e.g., a VPN), a cellular network, a satellite network, one or more wireless access points, or a combination thereof connecting any number of mobile clients, fixed clients, and servers.

In accordance with implementations of the present disclosure, the example system 100 may identify preview text displayed to a user from a first resource 112 (e.g., a webpage, an internet news page, a search results page, a blog page, a content aggregator app or page, a web application, e.g., a mobile web app) and, in response to receiving a user selection to view a second resource 112, locate the preview text within a body of text contained in the second webpage and indicate the location of the preview text to the user. For example, the first resource 112 may be a news webpage including a list of linked news articles. The list may include preview text excerpted from an article and a link (e.g., a hyperlink) to an associated webpage (or webpages) including the text of the respective article. When a link associated with a particular article is selected by a user, the system 100 may identify the preview text associated with the selected article from within the text of the linked webpage (e.g., the second resource 112). At least a portion of the preview text may be highlighted within the text of the article on the linked webpage, so as to quickly guide the user to the end of the preview text (which the user has likely already read) and to the remainder of the article (which the user has likely not yet read).

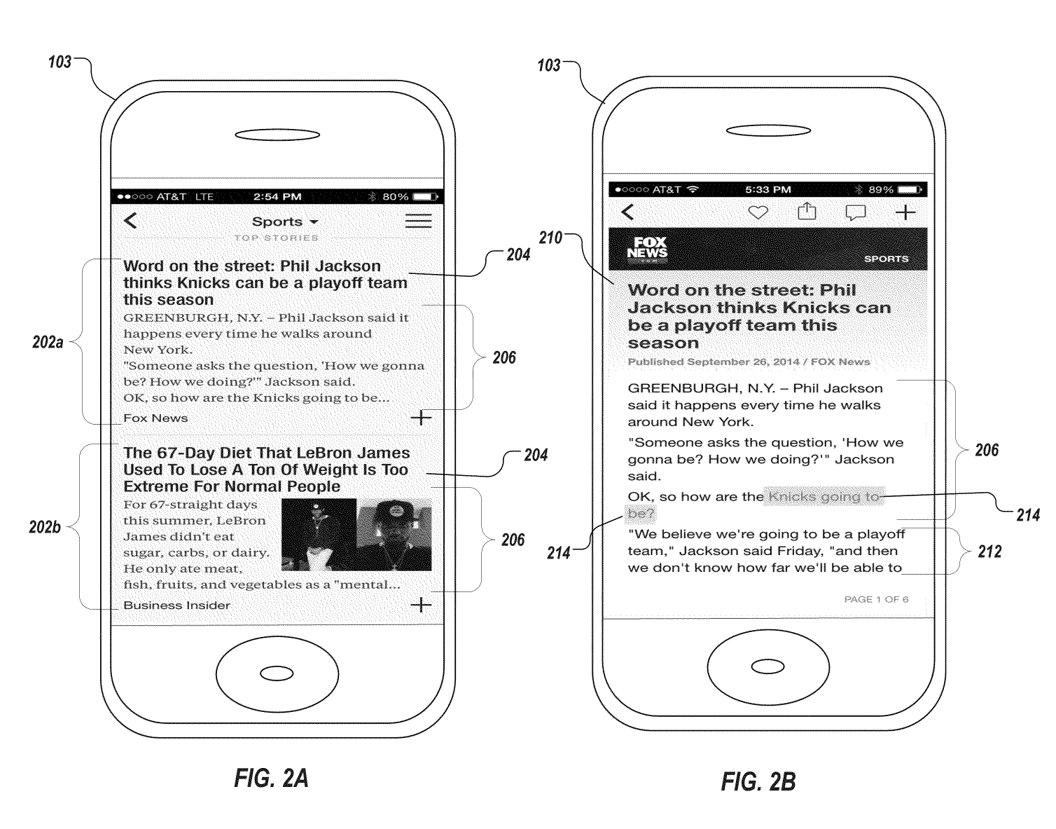

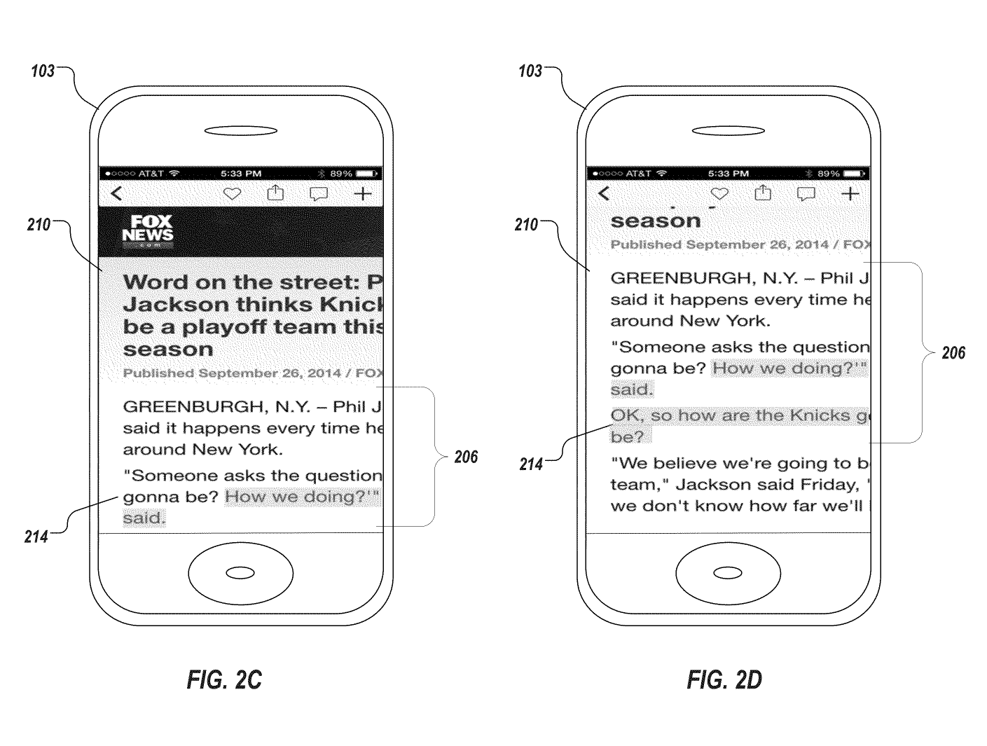

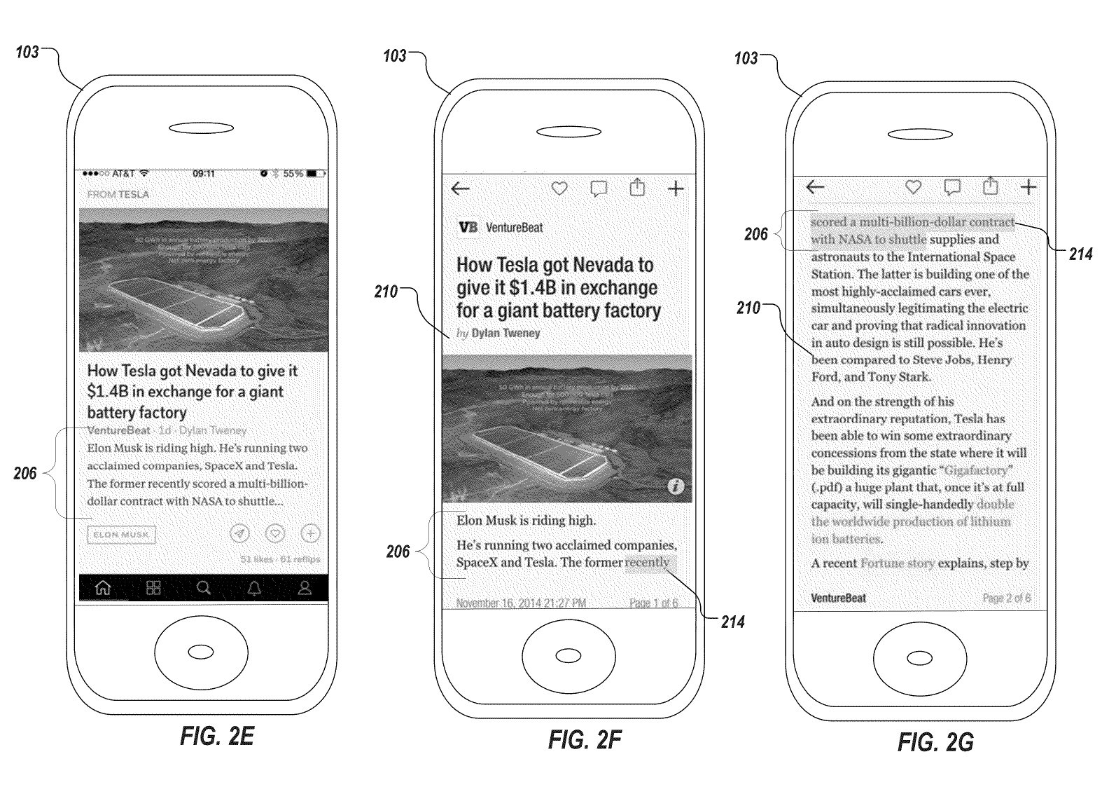

In more detail, FIGS. 2A-2D depict an example use case in accordance with implementations of the present disclosure. In FIGS. 2A-2C an example implementation is described in the context of a sports news application, however as noted above, implementations of the present disclosure may be may be applied in other forms of electronic resources (e.g., a webpage, an internet news page, a search results page, a blog page, a content aggregator app or page, a web application, e.g., a mobile web app). FIG. 2A depicts an example mobile device 103 displaying a sports news application. The sports news application includes a list of article entries 202a and 202b. Each article entry (202a and 202b) includes a user selectable link 204 (e.g., the link may be the article title or any portion of the article entry) to one or more webpages including the text of a respective article and preview text 206 excerpted from the article to provide the user with some context for the article.

A user may read the read the preview text 206 associated with article entry 202a and desire to read the rest of the article. The user may select the user selectable link 204 associated with article entry 202a. In response to receiving the user input, a mobile device 103 may access an appropriate webpage including the text of the selected article from a content server (e.g., content servers 102) or a local memory of the mobile device 103, and display the webpage, as shown in FIG. 2B.

FIG. 2B depicts an example second resource (e.g., webpage) including the text of the article 210 (e.g., a foxnews.com webpage entitled “Word on the street: Phil Jackson thinks Knicks can be a playoff team this season”). The article 210 text includes both the preview text 206 and additional text 212 of the article. The mobile device 103 may identify the preview text 206 within the article 210, and provide a user with a visual indication 214 of the location of the preview text 206 within the article 210. The visual indication 214 may enable a user to rapidly identify where to begin reading the article 210 without having to reread the preview text 206.

In some implementations, the visual indication 214 may include highlighting, bolding, italicizing, underlining, zooming (e.g., increasing a font size), or otherwise altering at least a portion of the preview text 206 within the article 210 such that a user can readily recognize where the preview text 206 ends and where the remainder of the article 210 (e.g., the additional text 212) begins. In some implementations, the visual indication 214 may include adding motion (e.g., a wiggle) to at least a portion of the preview text 206. In some implementations, the visual indication 214 may be applied to all of the preview text 206. In some implementations, the visual indication 214 may be applied to only a portion of the preview text 206, for example, the last several words (e.g., the last 1-10 words) of the preview text 206.

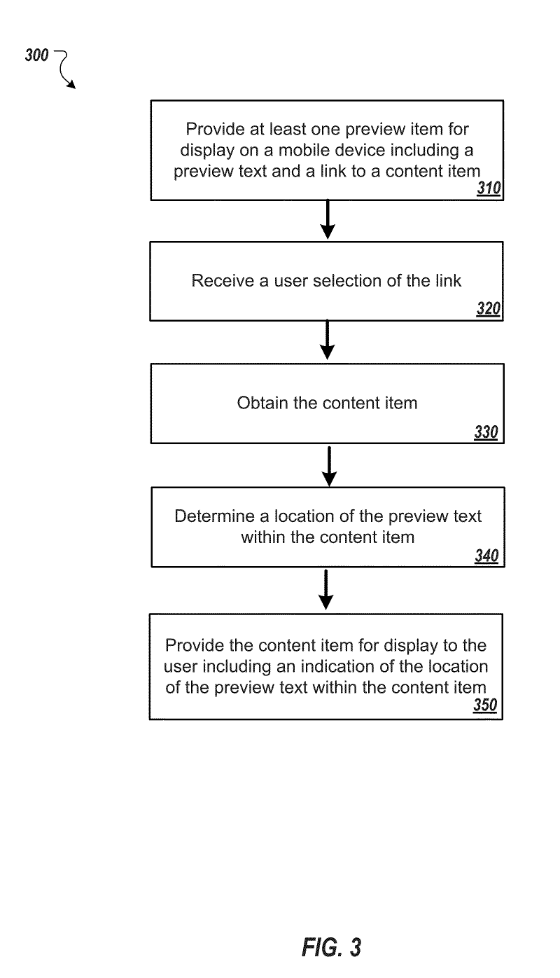

In some implementations, the type of visual indication 214, a portion of the preview text 206 to which the visual indication 214 is applied, or both may be determined based on the size of a mobile device's 103 display, a portion of the article displayed on the mobile device 103 (e.g., due to a zoom level of the mobile device), or both. For example, the smaller a mobile device's display or the greater the zoom level on a mobile device's display less text of the article will be displayed without having to scroll mobile device's display. It may therefore, be advantageous to, for example, apply the visual indication 214 to more or less of the preview text 206 such that at least a portion of the visual indication 214 is visible to user. For example, if a particular user has zoomed the display of their mobile device 103 as shown in FIG. 3C, not all of the preview text 206 is visible to the user. In such a situation, if the visual indication 214 is applied to only the last few words of the preview text, the user may not see the visual indication 214 until having reread at least some of the preview text 206. Thus, referring to FIGS. 2C and 2D, in some implementations, the mobile device 103 may determine the amount of text visible to the user and apply the visual indication 214 to at least a portion of the preview text 206 that is displayed on the display of the mobile device (e.g., visible to a user) and the preview text. In other words, the visual indication 214 may be applied to the last several words of the preview text 206 such that it is applied to at least one word of the preview text 206 that is displayed to the user when the webpage of the article 210 is initially loaded. The visual indication 214 may also be applied to the remainder of the preview text 206 up to the first word of the article 210 that was not part of the excerpted preview text 206. In the example shown, when the user then scrolls the displayed article 210 on the mobile device, as in FIG. 3D, the indication 214 will show the user the extent of the preview text 206 and where the unread (e.g., additional text 212) begins.

In some examples, as depicted in FIGS. 2E-2G, the preview text 206 may extend from a first page of an article 210 onto a second page of an article 210 (e.g., when a first page of an article contains an image, advertisement, or other content.) In some implementations, the visual indication 214 may be applied to, at least, a portion of the preview text 206 displayed on both the first and the second page of the article 210. For example, FIG. 2E shows an example preview text that states:
Elon Musk is riding high. He's running two acclaimed companies, SpaceX and Tesla. The former recently scored a multi-billion-dollar contract with NASA to shuttle . . . .

As shown in FIG. 2F, only the a portion of the preview text 206 (e.g., “Elon Musk is riding high. He's running two acclaimed companies, SpaceX and Tesla. The former recently”) is displayed on the first page of the associated article 210. The remainder of the preview text 206 (e.g., “scored a multi-billion-dollar contract with NASA to shuttle”) is displayed on the second page of the article 210, as shown in FIG. 2G. In order to provide a user with a positive indication that the preview text 206 wraps from one page of an article to another, for example, some implementations may apply the indication 214 to an ending portion (e.g., the last 1-5 words) of the preview text 206 displayed on a first page (e.g., as shown in FIG. 2F), and apply the indication 214 to all, or at least a portion of, the preview text 214 displayed on the second page (e.g., as shown in FIG. 2G).

FIG. 3 depicts an example process 300 that can be executed in accordance with implementations of the present disclosure. In some examples, the example process 300 can be provided as one or more computer-executable programs executed using one or more computing devices. Various implementations of the process 300 may be performed by a mobile device (e.g., a smartphone, a tablet, etc.), a computer, or another type of computing device. In some examples, the process 300 is executed to direct a user to the end of preview text within an article and into the beginning of the remaining text of the article. Process 300 may be performed by an application (e.g., a news application, a content aggregation application, a web browser) or a program module (e.g., an applet within a website). As an example, certain aspects of the process 300 may be performed by a content aggregation application running on a mobile device, such as, for example, FLIPBOARD provided by FLIPBOARD, INC. of Palo Alto, Calif., or another type of content aggregation application.

At least one preview item is provided for display on a mobile device (310). The at least one preview item includes a link to a content item and a preview text excerpted from the content item. The content item may be, for example, a web resource including, but not limited to, a webpage, a data or text file, a word processing document, or a portable document format (PDF) document, among other appropriate digital content. In some examples, the preview item is displayed in a preview interface of a content aggregation application on a mobile device, and the preview interface includes a series of preview items, each associated with a respective content item.

A user selection of the link is received (320). In response to the user selection of the link, the content item is obtained (330), a location of the preview text within the content item is determined (340), and the content item is provided for display to the user including an indication of the location of the preview text within the content item (350). For example, the indication may show a user where the preview text ends and where additional text within the context item begins. In some examples, the indication includes a visual indicator (e.g., highlighting, underlining, bolding, outlining, italicizing, font-resizing, text movement, etc.) at the end of the preview text, after the preview text (i.e., the beginning of unread text), or at a combination of these and other locations in the content item. In some cases, the visual indicator is provided for a predefined time duration, to allow the reader to find the end of the preview.

In some implementations, obtaining the content item includes retrieving the content item from a local memory. For example, the content item may be pre-loaded on the mobile device when the preview is initially displayed. In some implementations, sending a request from the mobile device to a remote computing system, and receiving the content item in response to the request.

In some implementations, the indication may include highlighting at least a portion of the preview text within the content item, for example, highlighting one or more words at the end of the preview text within the content item. In some implementations, the indication may include bolding at least a portion of preview text within the content item.

In some implementations, the process 300 may include determining that a first portion of the preview text is displayed on the mobile device (e.g., is visible to a user on the display of the mobile device) and that a second portion of the preview text is not displayed on the mobile device (e.g., the second portion is not currently displayed but a user must scroll the display of the mobile device for the second portion to be displayed). The indication of the location of the preview text may be applied to the second portion of the preview text and at least part of the first portion of the preview text. In other words, the indication may be applied to all of the second portion of the preview text and only part (e.g., several words) of the first portion of the preview text.

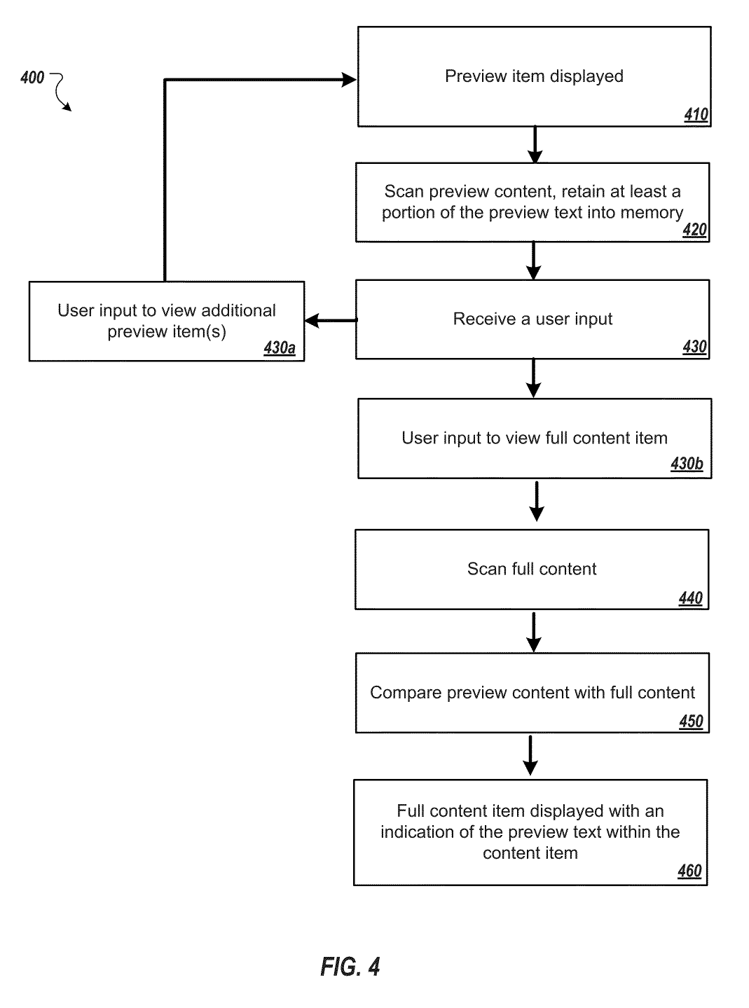

FIG. 4 depicts an example process 400 that can be executed in accordance with implementations of the present disclosure. In some examples, the example process 400 can be provided as one or more computer-executable programs executed using one or more computing devices. Various implementations of the process 400 may be performed by a mobile device (e.g., a smartphone, a tablet, etc.), a computer, or another type of computing device. In some examples, the process 400 is executed to direct a user to the end of preview text within an article, and into the beginning of the remaining text of the article. Process 400 may be performed by an application (e.g., a news application, a content aggregation application, a web browser) or a program module (e.g., an applet within a website). As an example, certain aspects of the process 400 may be performed by a content aggregation application running on a mobile device, such as, for example, FLIPBOARD provided by FLIPBOARD, INC. of Palo Alto, Calif., or another type of content aggregation application.

At least one preview item is displayed (410). Content of the preview item is scanned, and at least a portion of the preview text is stored into memory (420). Some or all of the preview text associated with the preview item may, for example, be stored in memory at a mobile device, at a computer system, or at a server (e.g., at a web server that is executing process 400 as a program module of a website). In some examples, only a last portion (e.g., the last 5-50% or the last 1-10 words) of the preview text may be stored. For example, referring to the example in FIG. 2B, the entire preview text states:
GREENBURGH, N.Y.—Phil Jackson said it happens every time he walks around New York.
“Someone asks the question, ‘How we gonna be? How we doing?’” Jackson said.
Ok, so how are the Knicks going to be?

Thus, in some implementations, for example, only the portion of the preview text including: “so how are the Knicks going to be?” may be stored.

A user input is received (430). If the user input is an input to view one or more additional preview items (430a), process 400 returns to step (410) and an additional one or more preview items are provided for display on the mobile device. For example, the user may not wish to view the content items associated with the displayed one or more preview items, and may provide an input to view a second set of one or more different preview items. In response, the mobile device may obtain a new set of one or more preview items different from those previously displayed.

If the user input is an input to view the full content item (430b), then, in response to the user input, the full content item is obtained and scanned (440), the stored portion of the preview text is compared with the full content item (450), and the full content item is displayed with an indication of the preview text within the full content item (460). For example, the some or all of the text contained in the full content item may be compared and matched to the stored portion of the preview text to identify the stored portion of the preview text within the content item. The indication may be applied to the identified part or all of the identified portion of the preview text within the content item. For example, the indication may show a user where the preview text ends and where additional text within the context item begins.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal; a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of displaying text on a mobile device, the method comprising:
providing a preview item for display on a mobile device, the preview item comprising a preview text excerpted from an associated content item;
receiving a user selection of the preview item displayed on the mobile device;
in response to the user selection of the preview item:
determining, by one or more processors, a location of the preview text within the content item associated with the preview item; and
providing, for display on the mobile device, the content item and an indication of the location of the preview text within the content item.

2. The method of claim 1, wherein providing the indication comprises highlighting at least a portion of the preview text within the content item.

3. The method of claim 2, wherein providing the indication comprises highlighting one or more words at the end of the preview text within the content item.

4. The method of claim 1, wherein the content item comprises web content that is accessible to the mobile device over a public data network, the method comprises, in response to the user selection of the preview item, obtaining the content item.

5. The method of claim 1, wherein the preview item is displayed in a preview interface of a content aggregation application on the mobile device, the preview interface comprises one or more other preview items, and each of the other preview items is associated with a respective content item and comprises preview text excerpted from the respective content item.

6. The method of claim 5, further comprising, in response to the user selection of the preview item:
sending a request from the mobile device to a remote computing system; and
receiving the content item in response to the request.

7. A mobile device comprising:
a display;
memory configured to store data; and
one or more processors configured to interact with the memory, the one or more processors being further configured to perform operations comprising:
providing a preview item for presentation on the display, the preview item comprising a preview text excerpted from an associated content item;
receiving a user selection of the preview item presented on the display;
in response to the user selection of the preview item:
determining a location of the preview text within the content item associated with the preview item; and
providing, for presentation on the display, the content item and an indication of the location of the preview text within the content item.

8. The mobile device of claim 7, wherein providing the indication comprises highlighting at least a portion of the preview text within the content item.

9. The mobile device of claim 8, wherein providing the indication comprises highlighting one or more words at the end of the preview text within the content item.

10. The mobile device of claim 7, wherein the content item comprises web content that is accessible to the mobile device over a public data network, and the mobile device comprises a communication interface configured to communicate over the public data network.

11. The mobile device of claim 7, wherein the preview item is presented in a preview interface generated by a content aggregation application, the preview interface comprises one or more other preview items, and each of the other preview items is associated with a respective content item and comprises preview text excerpted from the respective content item.

12. The mobile device of claim 11, further comprising a communication interface, the operations further comprising, in response to the user selection of the preview item:
providing a request for transmission via the communication interface; and
receiving, via the communication interface, the content item in response to the request.

13. A non-transitory computer-readable medium comprising instructions that, when executed by one or more processors, perform operations comprising:
providing a preview item for presentation on a display component, the preview item comprising a preview text excerpted from an associated content item;
receiving a user selection of the preview item;
in response to the user selection of the preview item:
determining a location of the preview text within the content item associated with the preview item; and
providing, for presentation on the display component, the content item and a visual demarcation of the location of the preview text within the content item.

14. The non-transitory computer-readable medium of claim 13, wherein the display component comprises a display of a mobile device.

15. The non-transitory computer-readable medium of claim 13, wherein providing the visual demarcation comprises highlighting at least a portion of the preview text within the content item.

16. The non-transitory computer-readable medium of claim 15, wherein providing the visual demarcation comprises highlighting one or more words at the end of the preview text within the content item.

17. The non-transitory computer-readable medium of claim 13, wherein the content item comprises web content.

18. The non-transitory computer-readable medium of claim 13, wherein the preview item is presented in a preview interface of a content aggregation application, the preview interface comprises one or more other preview items, and each of the other preview items is associated with a respective content item and comprises preview text excerpted from the respective content item.
